(19) United States
(12) Patent Application Publication
(10) Pub. No.: US 2026/0350098 A1
(43) Pub. Date: Nov. 5, 2026

(54) IDEA GENERATION SUPPORT SYSTEM AND IDEA GENERATION SUPPORT METHOD

(71) Applicant: HITACHI, LTD., Tokyo (JP)

(72) Inventors: Akinori ASAHARA, Tokyo (JP); Yoshihiro OSAKABE, Tokyo (JP); Karin TSUDA, Tokyo (JP); Hidekazu MORITA, Tokyo (JP)

(21) Appl. No.: 19/120,345

(22) PCT Filed: Oct. 30, 2023
(86) PCT No.: PCT/JP2023/039020

§ 371 Date: Apr. 11, 2025

(30) Foreign Application Priority Data
Nov. 30, 2022 (JP) 2022-191888

(51) Int. Cl. G06F 16/906

(52) U.S. Cl. CPC G06F 16/906

(57) ABSTRACT

A user idea that is a current user's idea is received, from among idea candidates accumulated in an idea candidate database in which the idea candidates that are existing ideas are accumulated, an idea candidate associated with the user idea is selected as a first idea candidate, a second idea candidate in which a classification of the selected first idea candidate is converted into a classification of the user idea is generated, and the user idea, the first idea candidate, and the second idea candidate are presented to a user in association with each other.

### TECHNICAL FIELD

The present invention relates to an idea generation support system and an idea generation support method, and is suitably applied to, for example, an idea generation support system that presents information for supporting people's idea generation.

### BACKGROUND ART

Workers engaged in research and development or planning may be required to have new ideas distinct from known ones. In such a case, the workers often deepen their own thoughts and collect related information in order to obtain new ideas.

As a method for expanding the thinking, in the related art, there is a method called brainstorming in which multiple people sequentially come up with ideas and expand the thinking based on the ideas. According to the brainstorming, there is an advantage that the idea can be expanded by borrowing other people's thinking.

When trying to obtain new ideas in this way, it is difficult for one person to expand his/her idea, and thus multiple people often cooperate. However, according to this method, there is a problem that it is difficult to gather for cooperation with other workers because multiple people need to meet face-to-face or online at the same time for a meeting, or there is a difference in prerequisite knowledge between the gathered workers.

Therefore, in recent years, systems have been developed which randomly present information to expand a serendipitous idea so that even one person can expand his/her idea.

For example, PTL 1 discloses a method of schematizing a user's idea based on a draft expressing the idea and presenting a relationship between constituent elements in an easy-to-understand manner to create a text expressing the idea more clearly.

In addition, PTL 2 discloses a method of presenting an element that may be naturally included in a user's idea based on words appearing in a draft expressing the idea and appearance frequencies of the words in known data.

### CITATION LIST

### Patent Literature

PTL 1: JP application number 2006-313567

PTL 2: JP 2021-190090 A

### SUMMARY OF INVENTION

### Technical Problem

According to the technologies disclosed in PTLs 1 and 2, people's ideas are received in the form of text or the like, and a result obtained by analyzing the text or the like or a related word or the like is presented, so that it can encourage people to become aware of and come up with new ideas. However, unless the information presented in this case is new for the user, the idea cannot be expanded.

Therefore, it is conceivable to expand the user's idea by diverting the ideas of other fields to the field of the user by acquiring and presenting information in fields different from the field that the user wants to think about. By such a method, the new idea is expected to be expanded.

However, according to this method, information that is outside of the user's expertise may be presented. That is, since the information presented by this method is highly specialized, the information is difficult for a non-specialist person to interpret, and in order to utilize the information as an idea in his/her specialized field, understanding and consideration regarding such other field are required, and there is a problem that it takes much time and effort.

The present invention has been made in consideration of the above problems, and is to propose an idea generation support system and an idea generation support method that can support a user to easily generate a new idea without requiring time and effort.

### Solution to Problem

In order to solve such a problem, the present invention provides an idea generation support system that presents information supporting generation of a new idea, including: a reception unit that receives a user idea that is a current user's an idea candidate database in which idea candidates that are existing ideas are accumulated; a selection unit that selects, from among the idea candidates accumulated in the idea candidate database, the idea candidate associated with the user idea as a first idea candidate; a classification transfer unit that generates a second idea candidate in which a classification of the first idea candidate selected by the selection unit is converted into a classification of the user idea; and a presentation unit that presents the user idea, the first idea candidate, and the second idea candidate to a user in association with each other.

In addition, the present invention provides an idea generation support method executed by an idea generation support system that presents information supporting generation of a new idea, including: a first step of receiving a user idea that is a current user's idea; a second step of selecting, from among idea candidates accumulated in an idea candidate database in which the idea candidates that are existing ideas are accumulated, the idea candidate associated with the user idea as a first idea candidate; a third step of generating a second idea candidate in which a classification of the selected first idea candidate is converted into a classification of the user idea; and a fourth step of presenting the user idea, the first idea candidate, and the second idea candidate to a user in association with each other.

According to the idea generation support system and the idea generation support method of the present invention, it is possible to present information in other fields brought to the field of a user's idea in an easy-to-understand manner. Therefore, an analogy can be generated, and the user's idea can be enriched.

### Advantageous Effects of Invention

According to the present invention, it is possible to realize an idea generation support system and an idea generation support method that can support a user to easily generate a new idea without requiring time and effort.

### BRIEF DESCRIPTION OF DRAWINGS

FIG. 1 is a block diagram showing a logical configuration of an idea generation support system according to first to third embodiments.

FIG. 2 is a block diagram showing a hardware configuration of the idea generation support system.

FIG. 3 is a sequence diagram for explaining an overall flow of idea generation support by the idea generation support system.

FIG. 4 is a diagram showing a screen configuration example of an initial idea input screen.

FIG. 5 is a flowchart showing a processing procedure of analogy evoking information presentation processing.

FIG. 6 is a table for explaining user idea data.

FIG. 7 is a table for explaining idea candidate data.

FIG. 8 is a diagram showing a screen configuration example of an analogy evoking screen.

FIG. 9 is a flowchart showing a processing procedure of analogy evoking data selection processing.

FIG. 10 is a conceptual diagram for explaining the analogy evoking data selection processing.

FIG. 11 is a diagram showing a screen configuration example of a classification transfer result presentation screen.

FIG. 12 is a flowchart showing a processing procedure of classification transfer result presentation processing.

FIG. 13 is a table for explaining a data system of an idea classification conversion model.

FIG. 14 is a conceptual diagram for explaining idea candidate data conversion processing using the idea classification conversion model.

FIG. 15 is a diagram for explaining a method of creating training data for the idea classification conversion model.

FIG. 16 is a diagram showing a screen configuration example of an examination result screen.

FIG. 17 is a flowchart showing a processing procedure of classification transfer result presentation processing according to a second embodiment.

FIG. 18 is a diagram for explaining a method of creating training data for an idea classification conversion model according to the second embodiment.

FIG. 19 is a diagram showing a screen configuration example of an analogy evoking screen according to a third embodiment.

FIG. 20 is a diagram showing a screen configuration example of a classification transfer result presentation screen according to the third embodiment.

FIG. 21 is a diagram showing a configuration example of training data for an idea classification conversion model according to the third embodiment.

### DESCRIPTION OF EMBODIMENTS

Hereinafter, an embodiment of the present invention will be described in detail with reference to the drawings.

### (1) First Embodiment

### (1-1) Configuration of Idea Generation Support System According to Present Embodiment

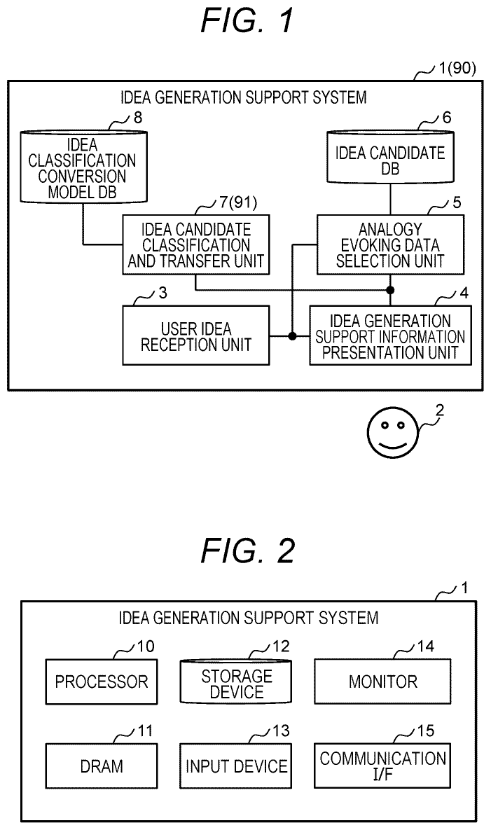

FIG. 1 shows a logical configuration example of an idea generation support system 1 according to the present embodiment. The idea generation support system 1 includes a user idea reception unit 3 that receives an input from a user 2, an idea generation support information presentation unit 4 that presents information to the user 2, an analogy evoking data selection unit 5 that selects information evoking an analogy to be presented to the user 2, an idea candidate database 6 that stores data of idea candidates (hereinafter, referred to as idea candidate data) to be described later, which are examples of the idea expressed, an idea candidate classification transfer unit 7 that generates an idea rewritten from information expressing an idea into an idea of another field, and an idea classification conversion model database 8 that stores machine learning model data for idea rewriting.

FIG. 2 shows a physical configuration example of the idea generation support system 1. As shown in FIG. 2, the idea generation support system 1 is formed of a general-purpose computer device including a processor 10 having calculation performance, a dynamic random access memory (DRAM) 11 that is a volatile temporary storage medium capable of high-speed reading and writing, a storage device 12 that provides a permanent storage region using a hard disk drive (HDD), a flash memory, or the like, an input device 13 that includes a mouse, a keyboard, or the like for the user to operate the idea generation support system 1, a monitor 14 for showing an operation to the user, and a communication interface 15 such as a serial port for communication with the outside.

The user idea reception unit 3, the idea generation support information presentation unit 4, the analogy evoking data selection unit 5, and the idea candidate classification transfer unit 7 in FIG. 1 are functional units embodied by the processor 10 executing a program stored in the storage device 12. In addition, the idea candidate database 6 and the idea classification conversion model database 8 are embodied by the processor 10 executing a program for accumulating data in the storage device 12.

### (1-2) Idea Generation Support Processing

### (1-2-1) Flow of Idea Generation Support by Idea Generation Support System

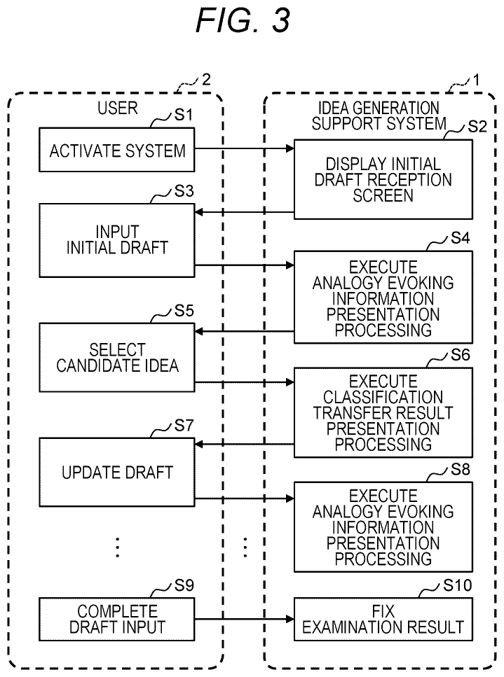

FIG. 3 shows a flow of idea generation support by the idea generation support system. FIG. 3 shows the interaction conducted between the user 2 and the idea generation support system 1 and the operation content in each element of the idea generation support system 1, focusing on the idea generation support processing executed by the idea generation support system 1 during idea generation support for the user 2.

As shown in FIG. 3, when the user 2 activates the idea generation support system 1 (S1), the idea generation support system 1 first displays (hereinafter, referred to as presents as appropriate) a predetermined initial draft reception screen for the user 2 to input an initial draft on a monitor 14 (FIG. 2) (S2). Then, when the user 2 inputs the initial draft to the initial draft reception screen (S3), the idea generation support system 1 executes analogy evoking information presentation processing to be described later to present one or more idea candidates for encouraging the user 2 to develop the idea, thereby guiding the thought of the user 2 to a new region (S4). Details of the analogy evoking information presentation processing will be described later.

Then, when the user 2 selects a desired idea candidate from among the idea candidates presented by the idea generation support system 1 (S5), the idea generation support system 1 executes classification transfer result presentation processing of generating and presenting a draft in which the idea candidate selected by the user 2 is rewritten to be in the classification of the initial draft (S6). Details of the classification transfer result presentation processing will also be described later.

Based on the draft presented as above, the user 2 can expand his/her idea by updating the draft (S7). Then, when the presented draft is updated by the user 2, the idea generation support system 1 executes the analogy evoking information presentation processing again to present one or more idea candidates for encouraging the user 2 to further develop the idea, and guides the thought of the user 2 to a further new region (S8).

Thereafter, the above steps S5 to S8 are similarly repeated, and when the user 2 finally determines that he/she has sufficiently changed the idea and performs a predetermined end operation (59), the idea generation support system 1 fixes the final draft as an examination result of the user 2 (S10). Therefore, the idea generation support by the idea generation support system 1 ends. Hereinafter, such a series of processing will be described in detail.

### (1-2-2) Initial Draft Reception Screen

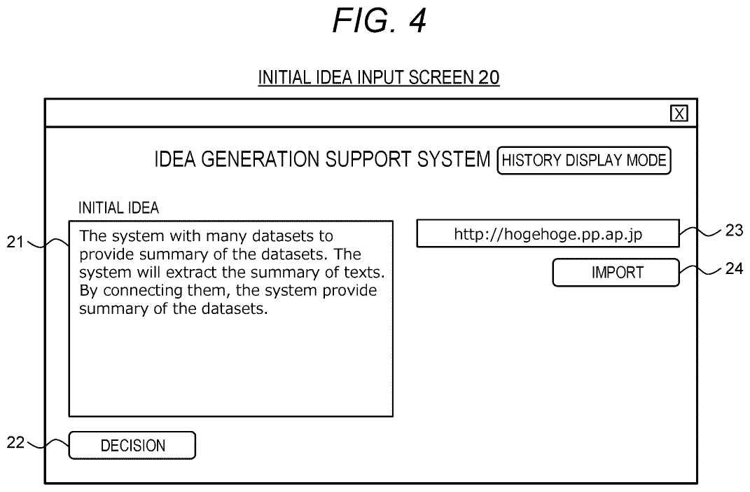

FIG. 4 shows a configuration example of an initial idea input screen 20 presented to the user 2 as the initial draft reception screen in step S2 described above. The initial idea input screen 20 is provided with an initial idea input text box 21 so that the user 2 can input his/her idea as a sentence into the initial idea input text box 21. In the following description, the expression “sentence” also includes “text”.

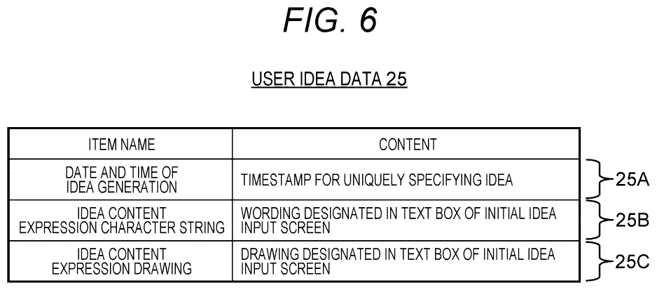

In addition, in the initial idea input text box 21 of the initial idea input screen 20, not only the sentence but also a drawing (hereinafter, referred to as an idea content expression drawing) and the like expressing the content of the initial idea of the user 2 can be embedded. In a case where an idea content expression drawing is embedded, data of the idea content expression drawing is included in user idea data 25 as an idea content expression drawing 25 °C to be described later with respect to FIG. 6.

In the initial idea input screen 20, data can also be acquired from the outside on the premise that there is another system that supports work of the user 2 to summarize the content of his/her idea into a sentence. In the example of FIG. 4, when a uniform resource locator (URL) on the Internet is input in a URL input text box 23, and then an import button 24 is clicked, information such as a text or a drawing can be automatically acquired from a web page of the URL, and the text or the drawing based on the acquired information can be displayed in the initial idea input text box 21.

### (1-2-3) Analogy Evoking Information Presentation Processing

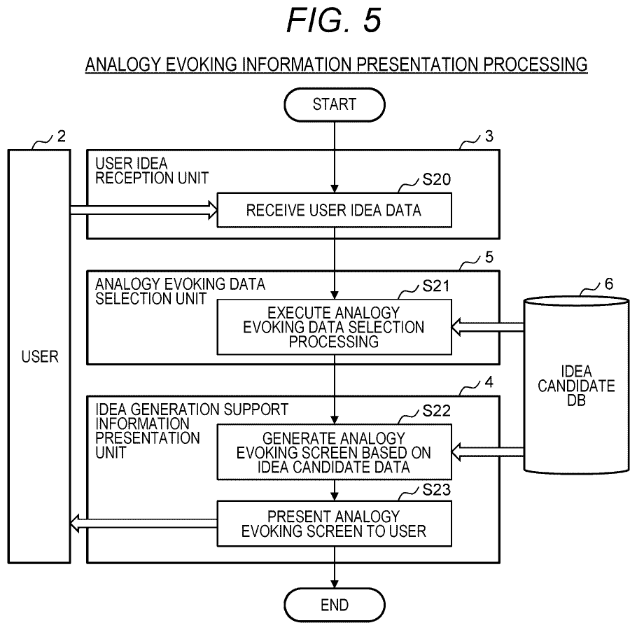

FIG. 5 shows a flow of the analogy evoking information presentation processing executed in the idea generation support system 1 in step S4 of FIG. 3. In the analogy evoking information presentation processing, first, the user idea reception unit 3 creates the user idea data 25 (FIG. 6) based on the user input and the like to the initial idea input screen 20 (FIG. 4) as described above, and sends the created user idea data 25 to the analogy evoking data selection unit 5 (S20).

FIG. 6 shows a configuration example of the user idea data 25. As shown in FIG. 6, the user idea data 25 is information including a date and time of idea generation 25A, an idea content expression character string 25B, and an idea content expression drawing 25C. The date and time of idea generation 25A is information indicating the date and time when the user idea data 25 was generated, and the idea content expression character string 25B is information indicating a character string (hereinafter, referred to as an idea content expression character string) of a sentence expressing the content of the initial idea of the user 2 input into the initial idea input text box 21 of the initial idea input screen 20 by the user 2.

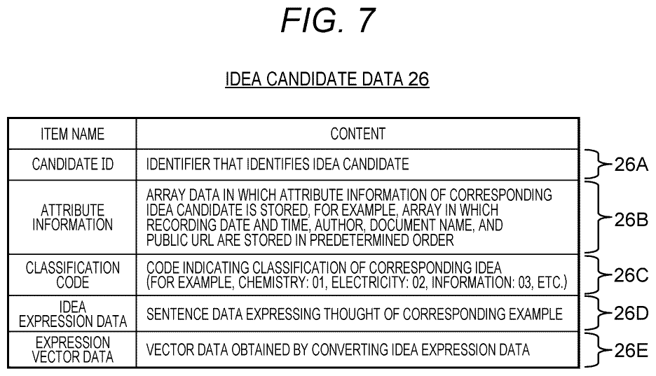

The analogy evoking data selection unit 5 executes analogy evoking data selection processing of selecting idea candidate data 26 (FIG. 7) of the idea candidate considered to contribute to the analogy from each idea candidate data stored in advance in the idea candidate database 6 based on the user idea data 25 sent from the user idea reception unit 3 (S21). Details of the analogy evoking data selection processing will be described later. The processing result of the analogy evoking data selection processing is a set of selected idea candidate data 26.

FIG. 7 shows a configuration example of the idea candidate data 26. The idea candidate data 26 includes information such as a candidate ID 26A, attribute information 26B, a classification code 26C, idea expression data 26D, and expression vector data 26E.

The candidate ID 26A is an identifier unique to the idea candidate data 26, which is assigned to the corresponding idea candidate data 26. In addition, the attribute information 26B is supplementary information regarding the idea candidate data 26 such as an author, and the classification code 26C indicates a code value indicating the classification of the idea candidate based on the idea candidate data 26, such as “01” for chemistry, “02” for electricity, and “03” for information.

In addition, the idea expression data 26D is data of a character string (idea content expression character string) of a sentence expressing the content of the idea candidate based on the corresponding idea candidate data 26, and the expression vector data 26E indicates expression vector data obtained by performing conversion processing to be described later on the idea expression data 26D.

The idea candidate database 6 can be prepared by, for example, acquiring and processing patent publications. Regarding the idea candidate database 6, crawling or the like may be periodically performed to add storage data as needed.

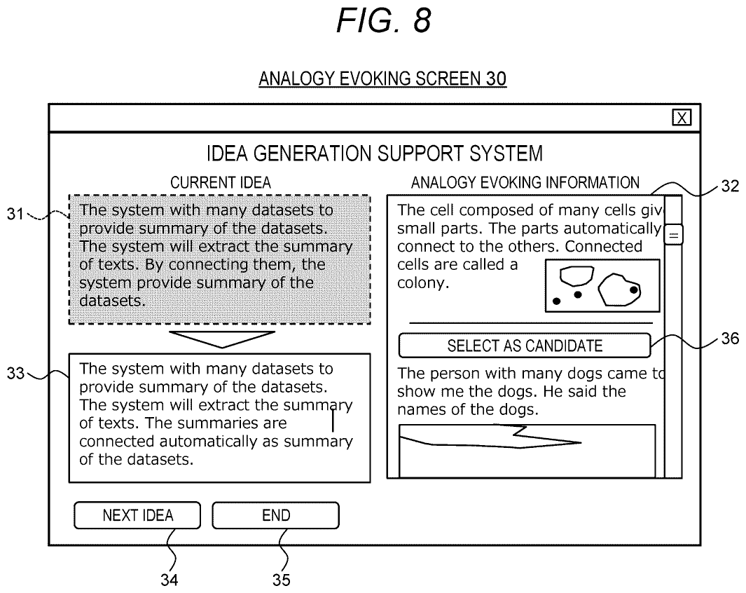

The idea candidate data 26 obtained as a result of the analogy evoking data selection processing is used for processing of generating an analogy evoking screen 30 to be described later with respect to FIG. 8 in combination with the user idea data 25 (FIG. 6) (S22). The generated analogy evoking screen 30 is presented to the user 2 (S23).

FIG. 8 shows a configuration example of the analogy evoking screen 30. As shown in FIG. 8, the analogy evoking screen 30 includes a present idea display field 31, an analogy evoking information display field 32, a user idea data display text box 33, a next button 34, and an end button 35.

In the current idea display field 31, an idea content expression character string based on the idea content expression character string 25B (FIG. 6) of the corresponding user idea data 25 (FIG. 6) and an idea content expression drawing based on the idea content expression drawing 25C (FIG. 6) are displayed. In this case, the idea content expression character string and the idea content expression drawing are displayed in a form that cannot be edited.

In addition, in the analogy evoking information display field 32, the content of each idea candidate data 26 (FIG. 7) selected by the above-described analogy evoking data selection processing is displayed so as to be a reference when editing the idea content expression character string or the idea content expression drawing currently displayed in the idea display field 31.

Specifically, as the content of each idea candidate data 26, information such as the attribute information 26B (FIG. 7) and the idea expression data 26D (FIG. 7) included in the idea candidate data 26 is displayed. When a URL is included in the attribute information 26B, information of the text or the drawing may be acquired from a web page of the URL and displayed in the analogy evoking information display field 32.

In addition, in the analogy evoking information display field 32, a selection button 36 is provided in association with each idea candidate data 26 selected by the analogy evoking data selection processing. By clicking the selection button 36, the idea candidate data 26 associated with the selection button 36 can be selected, and a character string and a drawing in which the idea expression data 26D based on the selected idea candidate data 26 is combined with the idea content expression character string and the idea content expression drawing based on the user idea data 25 currently displayed in the idea display field 31 can be displayed in the user idea data display text box 33.

In this case, in the user idea data display text box 33, the displayed sentence can be edited, and thus the user 2 can further expand the idea and express the content of the idea as a sentence with reference to the sentence displayed in the user idea data display text box 33.

Meanwhile, when the next button 34 is clicked in the analogy evoking screen 30, new user idea data 25 in which the date and time at that time is the date and time of idea generation, and the character string and the drawing stored at that time in the user idea data display text box 33 are the idea content expression character string and the idea content expression drawing, respectively, is generated, and the analogy evoking information presentation processing based on the generated user idea data 25 is executed again. This corresponds to step S8 of the processing described above with respect to FIG. 3.

In addition, when the end button 35 is clicked in the analogy evoking screen 30, the examination result is fixed. Such an operation of clicking the end button 35 corresponds to step S9 of the processing described above with respect to FIG. 3, and the processing of fixing the examination result thereby corresponds to step S10 in FIG. 3.

Next, the specific processing content of the analogy evoking data selection processing executed by the analogy evoking data selection unit 5 in step S21 of FIG. 5 will be described.

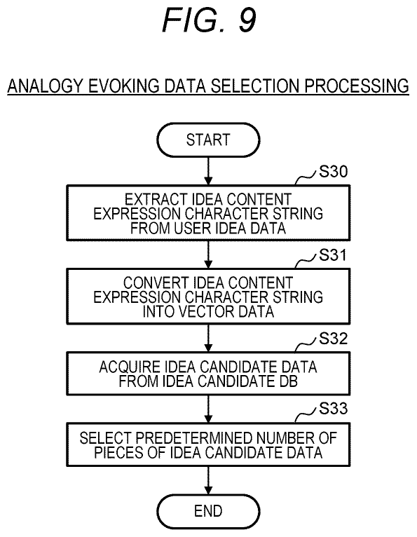

As shown in FIG. 9, the analogy evoking data selection unit 5 first extracts the idea content expression character string 25B (FIG. 6) from the user idea data 25 (FIG. 6) transmitted from the user idea reception unit 3 (S30), and converts the extracted idea content expression character string 25B into vector data (S31).

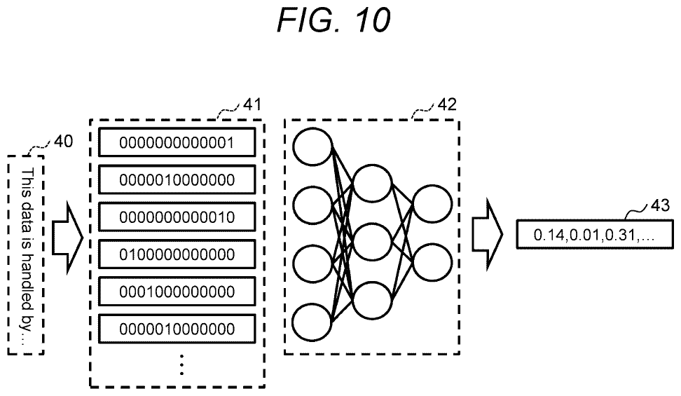

The vector data is a string of numerical values having a predetermined length, such as (0.1, 2.1, 1.2, 0.1, 0.6). When the idea content expression character strings 25B are similar, the vector data are also similar. That is, the idea content expression character string 25B is converted into vector data having a small inter-vector distance with the idea content expression character string 25B having a similar content. Such conversion processing will be described with reference to FIG. 10.

Known embedding processing can be applied for the conversion of a character string into vector data. In general, embedding refers to processing of converting data into vector data that maintains a mathematical structure of the data as much as possible. In the present embodiment, a method is applied in which the similarity between sentences is reflected in the distance between pieces of vector data.

As a character string embedding method, a method using a neural network such as Seq2Seq or Word2Vec is known. In the present embodiment, a target character string (here, idea content expression character string) 40 is divided into word units, and then converted into a vector string by a method called one-hot encoding.

In the one-hot encoding, each of components of a numerical string corresponds to each word obtained by the above-described division, and each word is converted so that only the corresponding component is “1” and other components are “0”. As a result, a vector string 41 in which only one of the components is “1” and the rest is “0” is generated.

Since the length of the string 41 varies depending on the character string to be input, the string is input to a neural network 42 incorporating a recurrent neural network or the like so as to be able to handle variable-length data. The neural network 42 is trained in advance using a large number of sentences. The training may be training of a neural network having an embedding function, and a known method can be used. Specifically, a generative adversarial network, a variational autoencoder, Transformer that is a method using an attention mechanism, or the like can be applied.

In these embeddings, the similarity of the input sentence is correlated with the distance between output vectors 43, but the viewpoint of the similarity of the sentence used differs depending on the technique. The type of embedding to be used can be selected according to the purpose of idea generation support by the idea generation support system 1 of the present invention or the like.

Using the vector data 43 generated as above, the idea candidate data 26 (FIG. 6) is acquired from the idea candidate database 6 (S32). The idea candidate data 26 includes the expression vector data 26E of FIG. 7.

Therefore, the distance between the vector data 43 generated as described above and the expression vector data 26E of each idea candidate data 26 stored in the idea candidate database 6 is calculated, and a predetermined number of pieces of idea candidate data 26, for example 10 pieces, are selected in ascending order of distance (S33). For example, a Euclidean distance between both vectors (the square root of the sum of squares of differences between components) is calculated, and the idea candidate data 26 in which the calculated Euclidean distance is equal to or less than a predetermined threshold is selected.

The distance between both vectors may be other than the Euclidean distance as long as the similarity can be evaluated. In addition, instead of specifying the number of pieces of idea candidate data 26 to be selected, a method of selecting all pieces of idea candidate data 26 with a distance smaller than a predetermined threshold may be adopted to select the idea candidate data 26.

Therefore, it is possible to present information stimulating the generation of ideas to the user 2.

### (1-2-4) Classification Transfer Result Presentation Processing

Next, the classification transfer result presentation processing executed by the idea candidate classification transfer unit 7 (FIG. 1) in step S6 of FIG. 3 will be described in detail. The classification transfer result presentation processing is processing that is executed when the selection button 36 (FIG. 8) associated with any idea candidate data 26 in which the idea expression data 26D (FIG. 7) is displayed in the analogy evoking information display field 32 in the analogy evoking screen 30 (FIG. 8) is clicked as described above.

With the classification transfer result presentation processing, a draft in which the content of the user idea data 25 at that time filled in the user idea data display text box 33 of the analogy evoking screen 30 described above with respect to FIG. 8 is combined with the idea candidate data 26 selected by the user 2 by clicking the selection button 36 is created and presented to the user 2.

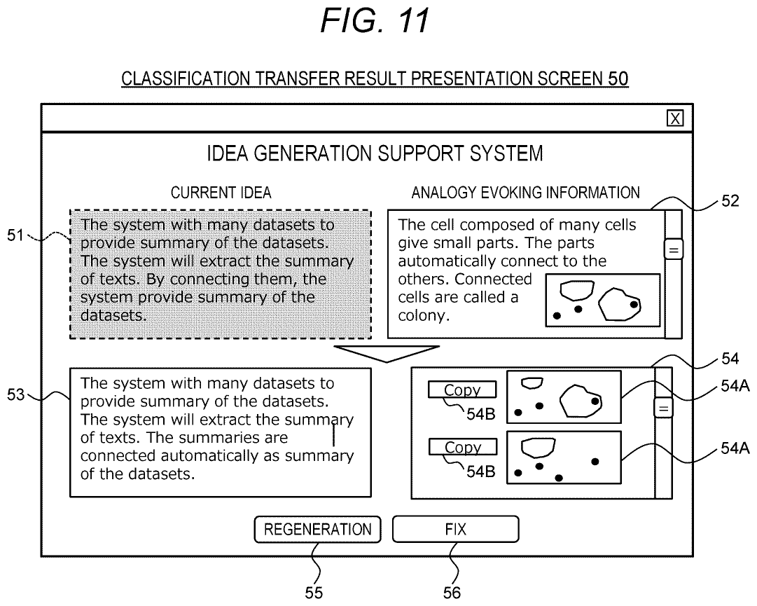

FIG. 11 shows a configuration example of a classification transfer result presentation screen 50 presented by the classification transfer result presentation processing. The classification transfer result presentation screen 50 includes a current idea display field 51, a selected idea candidate data display field 52, a user idea data display text box 53, a converted image list display field 54, a regeneration button 55, and a fix button 56.

In the current idea display field 51, an idea content expression character string based on the idea content expression character string 25B (FIG. 6) of the corresponding user idea data 25 and an idea content expression drawing based on the idea content expression drawing 25C (FIG. 6) are displayed. In this case, the idea content expression character string and the idea content expression drawing are displayed in the current idea display field 51 in a form that cannot be edited.

In addition, in the selected idea candidate data display field 52, a character string or a drawing representing the content of the idea candidate data (hereinafter, referred to as selected idea candidate data) 26 selected by clicking the selection button 36 (FIG. 8) in the analogy evoking information display field 32 (FIG. 8) of the analogy evoking screen 30 described above with respect to FIG. 8 is displayed.

The content of the selected idea candidate data 26 displayed in the selected idea candidate data display field 52 may be in a different field from the user idea data 25, but a draft in which the selected idea candidate data 26 is converted to be in the same field as the user idea data 25 is displayed in the user idea data display text box 53. The draft is displayed in an editable form, and the user 2 can freely edit the conversion result (draft).

In addition, when an image is included in the selected idea candidate data 26, the content of the image is also converted to be in the same classification as the user idea data, and results (hereinafter, referred to as converted images 54A) obtained by performing the conversion in several patterns are displayed as a list in a converted image list display field 54. These converted images 54A can be copied and used by clicking a corresponding copy button 54B displayed in the converted image list display field 54.

In addition, in the classification transfer result presentation screen 50, when the draft displayed in the user idea data display text box 53 is not preferable for the user 2, the draft can be regenerated and displayed in the user idea data display text box 53 by clicking the regeneration button 55.

Then, in the classification transfer result presentation screen 50, as a result of repeating such regeneration and editing, when the user 2 is satisfied with the draft displayed in the user idea data display text box 53, the draft can be fixed as an idea content expression character string or an idea content expression drawing to be used as the user idea data 25 in the next analogy evoking information presentation processing by clicking the fix button 56. Therefore, the classification transfer result presentation processing ends.

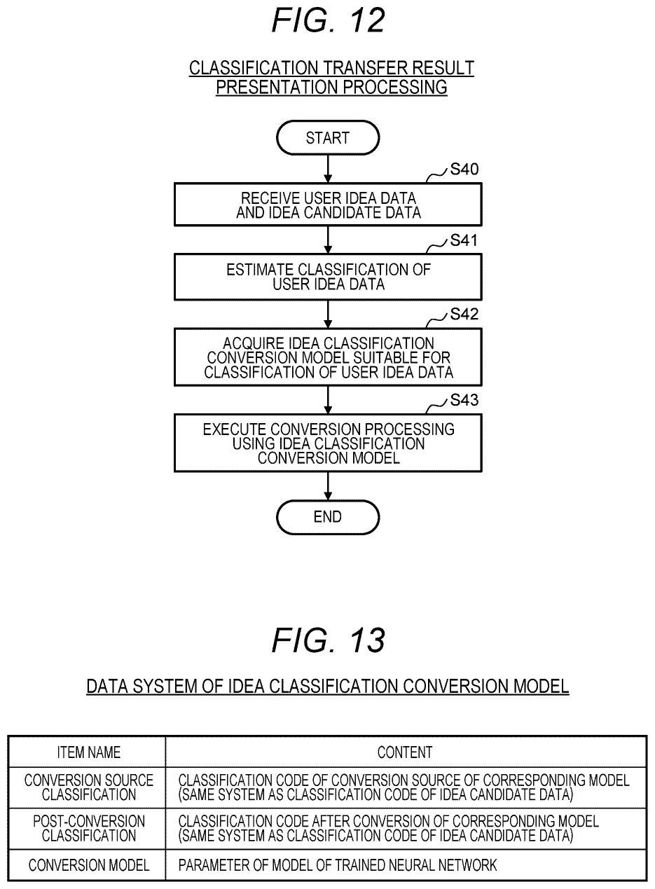

FIG. 12 shows a specific processing flow of the classification transfer result presentation processing executed by the idea candidate classification transfer unit 7 (FIG. 1) in step S6 of FIG. 3. As described above, the classification transfer result presentation processing is started when the selection button 36 associated with any idea candidate data 26 (FIG. 7) whose content is displayed in the analogy evoking information display field 32 of the analogy evoking screen 30 described above with respect to FIG. 8 is clicked.

Then, the idea candidate classification transfer unit 7 acquires the user idea data 25 created by the user idea reception unit 3 (FIG. 1) based on the information of the idea content expression character string and the idea content expression drawing of the user idea data 25 (FIG. 6) displayed in the user idea data display text box 33 of the analogy evoking screen 30 at that time, and acquires the idea candidate data 26 selected at that time (S40).

Next, the idea candidate classification transfer unit 7 estimates the classification of the user idea data 25 acquired in step S40 (S41). The estimation can be performed, for example, by giving a predetermined classification score to words appearing in the idea content expression character string and deciding the classification according to the sum of the scores.

Alternatively, after the idea content expression character string of the user idea data 25 is converted into vector data by the method described above with respect to FIG. 10, discrimination may be conducted by a known machine learning discrimination analysis method such as a decision tree or a support vector-machine, or the neural network 42 described above with respect to FIG. 10 may be modified to conduct the discrimination, so that it is possible to perform the estimation with high accuracy based on the preliminary learning.

Furthermore, a separate user interface for confirming the classification by the user may be prepared to manually perform the classification. In this case, although the amount of people's work increases, the accuracy of the classification increases.

In the above processing and work, the classification is performed in a system that is the same as or consistent with FIG. 7.

Next, the idea candidate classification transfer unit 7 selects a conversion model (hereinafter, referred to as an idea classification conversion model) for converting the classification of the idea based on the classification as described above (S42). Selecting the idea classification conversion model is performed by selecting an appropriate idea classification conversion model from among various idea classification conversion models stored in the idea classification conversion model database 8 (FIG. 1).

As shown in FIG. 13, the idea classification conversion model database 8 is a database in which, for each idea classification conversion model that is data of the trained machine learning model described above, a classification code of a conversion source and a classification code after conversion are stored in association with each other. As described above, since the purpose is to convert the idea candidate data 26 to be in the classification of the user idea data 25, an idea classification conversion model in which the classification code of the idea candidate data 26 corresponds to a conversion source classification and the classification estimation result for the user idea data 25 corresponds to a post-conversion classification is selected.

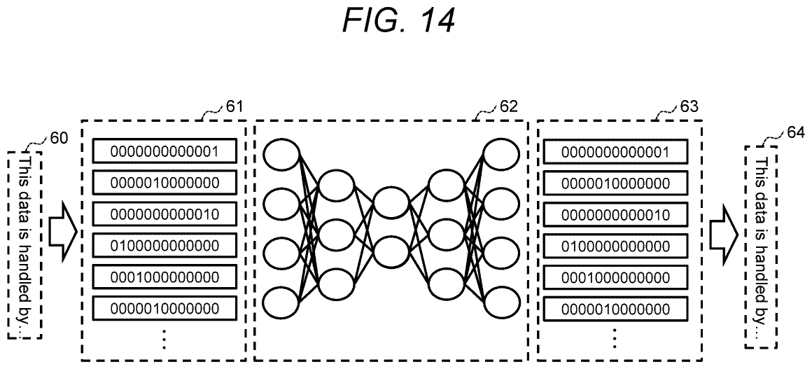

Finally, the idea candidate data 26 is converted using the idea classification conversion model, and the result is returned to the idea generation support £ information presentation unit 4 (S43). FIG. 14 schematically shows the above conversion, and shows a schematic representation of a neural network 62 that returns series data 64 with respect to series data 60 to the idea generation support information presentation unit 4. The input: series data 60 is once converted into a series 61 of One-Hot data, and then input to the neural network 62. Then, another series 63 of One-Hot data is obtained, and the series 63 can be converted into the series data 64 including a character string. Therefore, it is possible to handle a known text-to-text problem in which with a character string taken as an input, another character string is output.

In the present embodiment, the conversion is performed so that the input character string (series data 60) corresponds to the classification of the classification code of the conversion source classification in FIG. 13 and the output character string (series data 64) corresponds to the classification code of the post-conversion classification in FIG. 13. In order to train such an idea classification conversion model, it is necessary to prepare a large number of pairs of data obtained as a result of rewriting between the fields of the character strings.

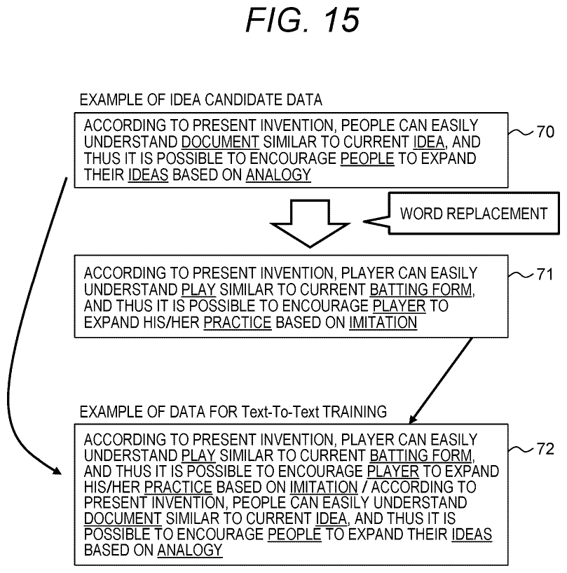

However, since it is not easy to prepare such data, a method of creating the data in a pseudo manner may be applied. For example, as shown in FIG. 15, by performing processing of extracting nouns from a sentence 70 of the existing idea candidate data 26 and randomly replacing the nouns with nouns in other fields, it is possible to create data of a sentence 71 subjected to the conversion between classifications in a simulating manner.

In addition, by combining the sentence 70 of the existing idea candidate data 26 with the sentence 71 in which the nouns in the sentence 70 are replaced with nouns in other fields, it is possible to create training data 72 for performing the conversion between classifications in a pseudo manner.

When the classification of the idea candidate data 26 is converted using the idea classification conversion model trained using the training data 72, the sentence of the idea candidate data 26 after classification conversion is converted into a sentence in which nouns are replaced with the nouns in other field described above while maintaining the original syntax.

In this method, the idea classification conversion model database 8 cannot be constructed unless similar training is performed for all combinations of the conversion between classifications. However, preliminary learning processing can be reduced by standardizing the classification of the inputs.

In this case, it is also possible to adopt a method of repeatedly performing the conversion to various fields with respect to the word replacement processing in FIG. 15 to construct, as training data, a data set for performing training for the purpose of converting a text in an arbitrary field into a text with a converted classification code (a classification code of the post-conversion classification in FIG. 13).

Here, any method can be applied as long as the input data can be converted into data in another specific field with the method. For example, the word replacement processing described above with respect to FIG. 15 can be used as it is.

In addition, in the present embodiment, only a character string has been described as a target, but similar processing can also be performed on images in a drawing. In a case of the drawing, similar processing can be performed by implementation based on an image style conversion method using a known generative adversarial network (GAN) or the like instead of text-to-text.

Similarly, as long as the form of expression itself can be understood by people and can express thoughts of people, any form of expression is acceptable, such as adding a voice reading function to expand the idea by natural interaction, or using a moving image or the like for expression, or a plurality of types may be combined.

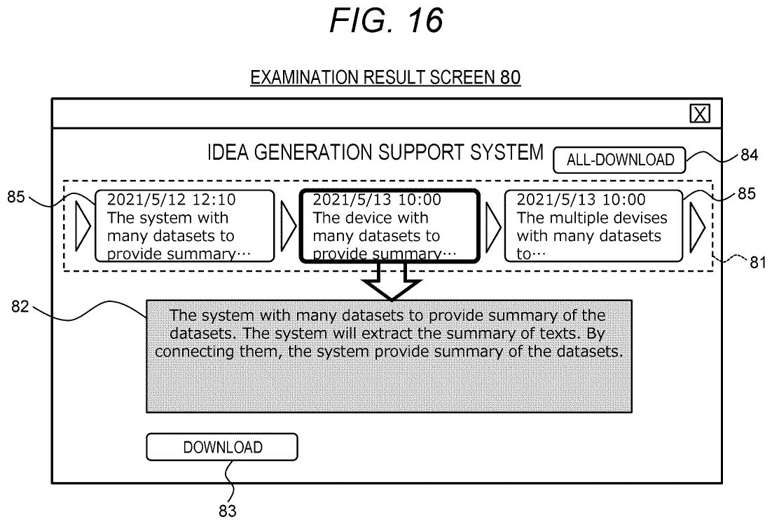

FIG. 16 shows a screen configuration example of an examination result screen 80 that is presented to the user 2 after the examination result is fixed in step S10 of FIG. 3 (after the fix button 56 in the classification transfer result presentation screen 50 described above with respect to FIG. 11 is clicked). The examination result screen 80 includes an intermediate draft list display region 81, a selected draft display field 82, a download button 83, and an all-download button 84.

Then, in the intermediate draft list display region 81, intermediate draft display fields 85 in which a part of the draft created in the course of examination so far is written are displayed side by side in the order in which they have been created. FIG. 16 illustrates a case where only three intermediate draft display fields 85 are displayed. However, in a case where there are four or more drafts created in the course of examination so far, the intermediate draft display fields 85 can be collectively moved in a horizontal direction by a predetermined operation. With such an operation, other intermediate draft display fields 85 virtually existing in the horizontal direction of the intermediate draft list display region 81 in the examination result screen 80 can be moved into the intermediate draft list display region 81 and displayed in a visible state.

In addition, in the examination result screen 80, by clicking one of the drafts each displayed in the intermediate draft display field 85 in the intermediate draft list display region 81, the intermediate draft display field 85 in which the clicked draft is displayed can be highlighted (the frame of the intermediate draft display field 85 is displayed thicker, or the like), and in this state, by clicking the download button 83, the entire draft a part of which is displayed in the intermediate draft display field 85 can be displayed in the selected draft display field 82.

Furthermore, in the examination result screen 80, by clicking the all-download button 84, all the drafts created in the course of examination so far can be downloaded to display the details thereof in the selected draft display field 82. In this case, by making it possible to download the drafts including the records in step S42 of FIG. 12 and by recording them in a form including the attribute information 26B (FIG. 7) and the like so that the idea candidate data 26 of the conversion source can be accessed at a later date, convenience can be enhanced.

### (1-3) Effects of Present Embodiment

As described above, in the idea generation support system 1 of the present embodiment, when a person has an initial idea and collects information to develop the idea, information on cases having similarity across fields is presented in an easy-to-understand manner. Therefore, according to the present idea generation support system 1, it is possible to generate an analogy and expand the idea abundantly, and it is possible to support the user to easily generate a new idea without requiring time and effort.

### (2) Second Embodiment

In FIG. 1, the reference numeral 90 denotes an idea generation support system according to a second embodiment a whole. The idea generation support system 90 is constituted similarly to the idea generation support system 1 of the first embodiment, except that the processing content of the classification transfer result presentation processing executed by an idea candidate classification transfer unit 91 in step S6 of FIG. 3 is different from that in the first embodiment.

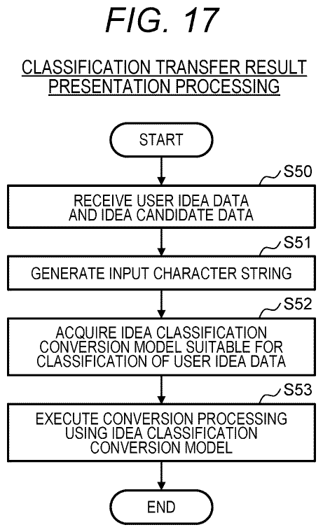

FIG. 17 shows a specific processing content of the classification transfer result presentation processing executed by the idea candidate classification transfer unit 91 of the present embodiment. The classification transfer result presentation processing is different from the classification transfer result presentation processing according to the first embodiment described above with respect to FIG. 12 in that classification estimation for user idea data is not performed in step S51, and other steps S50, S52, and S53 are respectively processed in the same manner as steps S40, S42, and S43 in FIG. 12.

Then, in the classification transfer result presentation processing of the present embodiment, instead of performing classification estimation for the user idea data 25 (FIG. 6) in step S51, the field of the idea candidate data 26 (FIG. 7) is converted directly using the user idea data 25. Therefore, in the present classification transfer result processing, in step S51, a character string in which both the user idea data 25 and the idea candidate data 26 are combined is generated, and the generated character string is put into an appropriate idea classification conversion model in the idea classification conversion model database 8 (FIG. 1) to convert the field. Therefore, it is not necessary to prepare a large number of idea classification conversion models, and as a result, it is possible to handle the processing by preparing only a single idea classification transfer model.

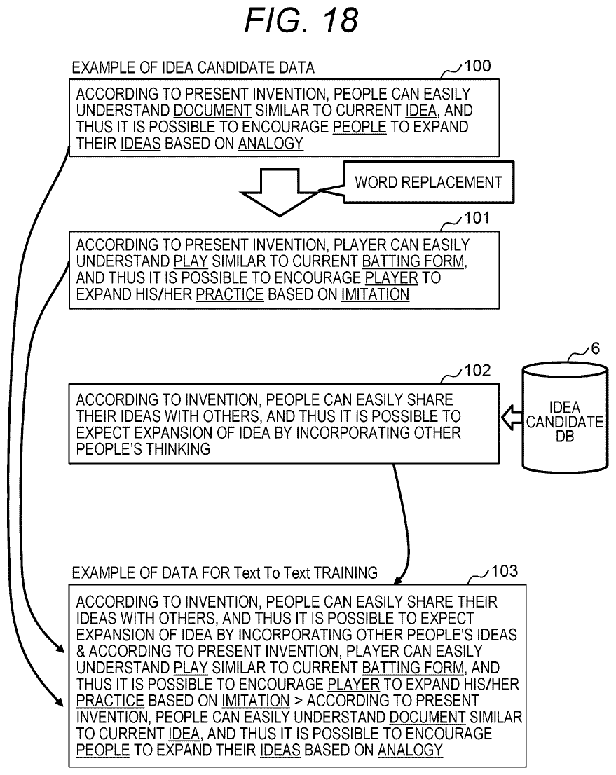

FIG. 18 schematically shows a learning method for the idea classification conversion model in the present embodiment. Similarly to the first embodiment, the idea classification conversion model itself used in the present embodiment only needs to correspond to text-to-text, and different data is used for training. In the present embodiment, training data includes a combination of three sentences (hereinafter, referred to as first to third sentences, respectively) 100 to 102.

The first sentence 100 is a sentence based on the idea expression data 26D (FIG. 7) in certain idea candidate data 26 (FIG. 7), and the second sentence 101 in which nouns in the first sentence 100 are replaced with those of another field (here, the field of the user idea data 25) is created in the same manner as in the first embodiment. Furthermore, another idea candidate data 26 belonging to the same classification as the idea candidate data 26 that is the first sentence 100 is acquired from the idea candidate database 6 (FIG. 1), and a sentence based on the idea expression data 26D of the acquired idea candidate data 26 is used as the third sentence 102. Then, the first to third sentences 100 to 102 are arranged in the order of the third sentence 102, a delimiter (“&” in FIG. 18), the second sentence 101, a delimiter (“>” in FIG. 18) representing the input/output boundary of text-to-text, and the first sentence 100, and this arrangement is defined as training data 103.

Therefore, as for the text-to-text problem, machine learning is performed in response to a problem that a character string in which a sentence example in a predetermined classification and a sentence example in another field are combined with a delimiter interposed therebetween is input, and a character string in which classification conversion is performed on the latter half of the input sentence is output. When data in which the user idea data 25 and the idea candidate data 26 described above are arranged is given to the idea classification conversion model machine-learned as above, a character string in which a sentence based on the latter half, that is, the idea expression data 26D of the idea candidate data 26 is converted to be in the field of the user idea data 25 is output.

Any method can be applied as long as processing capable of producing a similar result is performed. For example, by applying a bias regarding classification to the course of calculation of the neural network 62 of FIG. 14, it is possible to expect that a similar result can be obtained without using the data of FIG. 18.

According to the idea generation support system 90 of the second embodiment described above, since it is only necessary to prepare a single idea classification conversion model for idea classification, classification conversion can be executed even when the number of pieces of training data is smaller than that in the idea generation support system 1 of the first embodiment.

### (3) Third Embodiment

In the present embodiment, idea generation support for a chemical formula will be described. In the present embodiment, an object is to find, when searching for an organic compound for a specific application, a structural formula of a better organic compound by incorporating characteristics of an organic compound used in other applications. Since the configuration of an idea generation support system of the present embodiment is similar to those of the idea generation support system 1 of the first embodiment and the idea generation support system 90 according to the second embodiment, description thereof will be omitted here.

The structural formula of an organic compound can be expressed as a character string in a format such as known simplified molecular input line entry syntax (SMILES) . Therefore, it is sufficient that the character string handled substantially equivalent to the configuration handling the character string described in the first embodiment and the second embodiment has simply been changed to one expressing the structural formula, and the character string may be expressed in the form of structural formula when being displayed on the screen.

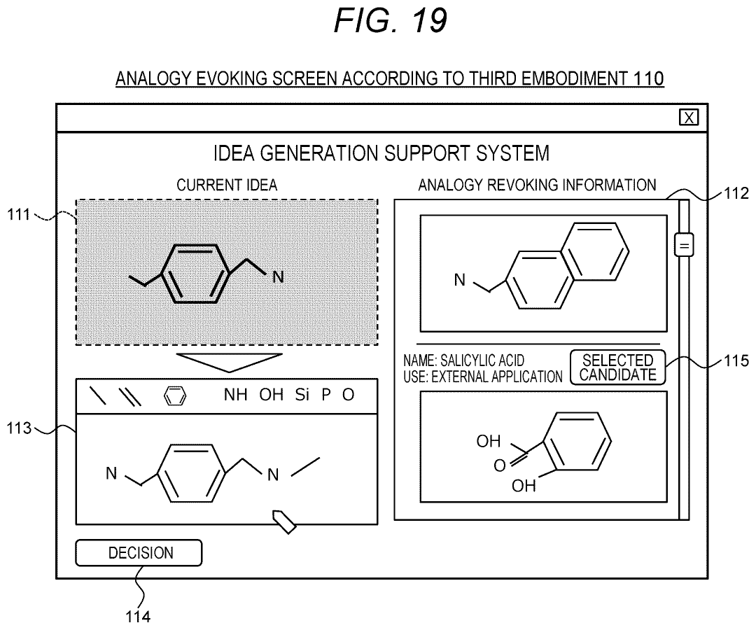

FIG. 19 shows an example of an analogy evoking screen 110 presented by the idea generation support information presentation unit 4 in step S23 of the analogy evoking information presentation processing described above with respect to FIG. 5. The analogy evoking screen 110 includes a current idea display field 111, an analogy evoking information display field 112, a current idea editing field 113, and a decision button 114.

Then, in the current idea display field 111, a chemical formula (hereinafter, referred to as a first chemical formula) based on the current user idea data 25 is displayed as a drawing. In addition, in the analogy evoking information display field 112, several chemical formulas (hereinafter, referred to as second chemical formulas) which are based on the idea expression data 26D (FIG. 7) of any idea candidate data 26 (FIG. 7) and are similar to the first chemical formula are displayed as analogy evoking information. Therefore, a user can expand the idea while referring to the second chemical formulas displayed in the analogy evoking information display field 112.

In this case, for each chemical formula displayed in the analogy evoking information display field 112, information included in the attribute information 26B (FIG. 7) of the idea candidate data 26 described above with respect to FIG. 7, such as a Japanese name and a use, is displayed together, so that the information can be presented to the user 2 in an even easier-to-understand manner.

Furthermore, the chemical formula expressing the current idea of the user 2 displayed in the current idea display field 111 is also displayed in the current idea editing field 113, and can be corrected in the current idea editing field 113.

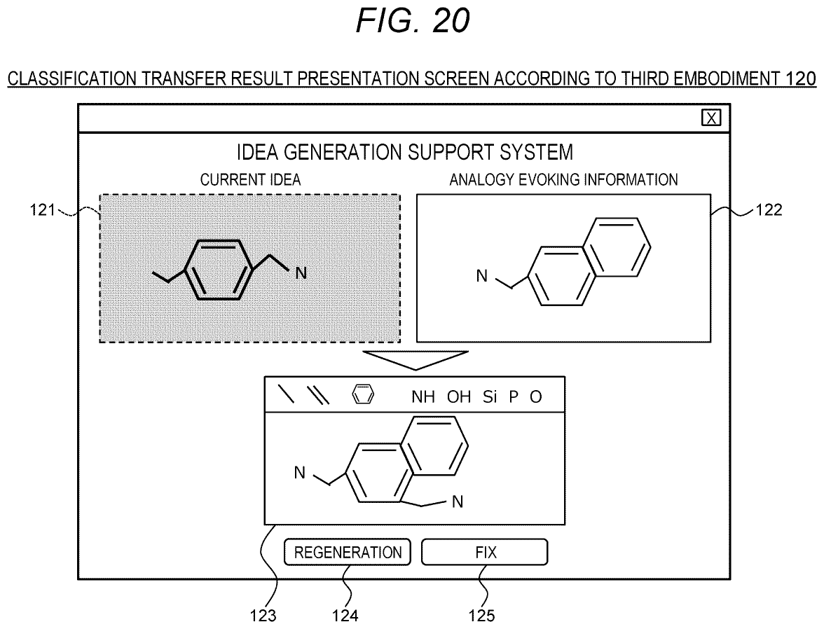

Then, in the analogy evoking screen 110, selected candidate buttons 115 are provided in the analogy evoking information display field 112 to respectively correspond to the chemical formulas displayed in the analogy evoking information display field 112, and when a selection button 105 corresponding to the desired chemical formula is clicked to select the chemical formula, it is possible to cause the idea candidate classification transfer unit 7 (FIG. 1) to execute the above-described field transfer result presentation processing. Then, the processing result of the field transfer result presentation processing is seen on a classification transfer result presentation screen 120 shown in FIG. 20 and presented to the user 2.

As shown in FIG. 20, the classification transfer result presentation screen 120 includes a current idea display field 121, a selected idea candidate data display field 122, a user idea data display text box 123, a regeneration button 124, and a fix button 125.

Then, a chemical formula created from the character string of the user idea data 25 is displayed in the current idea display field 121, and a chemical formula selected as described above in the analogy evoking screen 110 is displayed in the selected idea candidate data display field 122.

In addition, in the user idea data display text box 123, a result obtained by converting the chemical formula displayed in the selected idea candidate data display field 122 to be in the same classification as the user idea data 25 in which the chemical formula corresponding to the current idea display field 121 is displayed is displayed in an editable state. The classification mentioned herein refers to, for example, conversion between uses (external preparation, food additive, heat insulating material, and the like), conversion between compound species (Si-based compound, monomer, polymer, and the like), and the like.

In addition, in the classification transfer result presentation screen 120, when the chemical formula displayed in the user idea data display text box 123 is not preferable for the user 2, the chemical formula can be regenerated and displayed in the user idea data display text box 123 by clicking the regeneration button 124.

Then, in the classification transfer result presentation screen 120, as a result of repeating such regeneration and editing, when the user 2 is satisfied with the chemical formula displayed in the user idea data display text box 123, the chemical formula can be fixed as an idea content expression character string or an idea content expression drawing to be used as the user idea data 25 in the next analogy evoking information presentation processing by clicking the fix button 125.

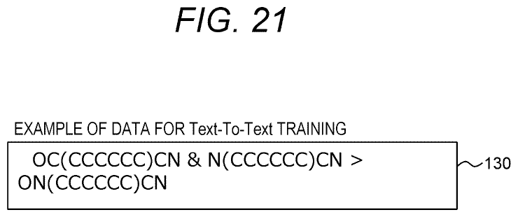

FIG. 21 shows an example of training data 130 for training the idea classification conversion model stored in the idea classification conversion model database 8 (FIG. 1) in the third embodiment. The training data 130 is basically equivalent to the training data 103 in the second embodiment described above with respect to FIG. 18, and is different only in that the used character string is not a natural language but a character string expressing a chemical formula.

In addition, since a mathematical formula can be handled as a character string by using a known expression format such as TeX or mathematical markup language (MathML), the mathematical formula can be handled in the same manner as in the first and second embodiments. Furthermore, in addition to this, information that can be expressed as a character string, such as a program code, markup data such as hyper text markup language (HTML), a drawing command string of a drawing, a network structure of a neural network or the like, and a diagram of a unified modeling language (UML) class diagram, can be handled similarly.

According to the idea generation support system of the present embodiment, it is possible to expect an effect of expanding the ideas to a wider range of ideas.

### (4) Other Embodiments

In the above-described first to third embodiments, a case has been described in which various functions such as the user idea reception unit 3, the idea generation support information presentation unit 4, the analogy evoking data selection unit 5, the idea candidate database 6, the idea candidate classification transfer units 7 and 91, and the idea classification conversion model database 8 of the idea generation support systems 1 and 90 are mounted on one computer device, but the present invention is not limited thereto. These functions may be distributed and disposed in a plurality of computer devices constituting a distributed computing system.

In addition, in the above-described first embodiment, as described above with respect to FIG. 15, a case has been described in which by performing processing of extracting nouns from the sentence 70 of the existing idea candidate data 26 and randomly replacing the nouns with nouns in other fields, data of the sentence 71 subjected to the conversion between classifications in a simulating manner is created, the training data 72 is created using data of the created sentence 71, and the classification of the idea candidate data 26 is converted using the idea classification conversion model trained using the created training data 72, but the present invention is not limited thereto. For example, the idea candidate classification transfer unit 7 may replace words such as nouns with words in the classification of the user idea data 25 while maintaining the syntax of the sentence of the existing idea candidate data 26, so that the classification of the existing idea candidate data 26 may be converted into the classification of the user idea data 25.

### INDUSTRIAL APPLICABILITY

The present invention can be widely applied to idea generation support systems of various configurations that present information supporting the generation of a new idea.

### REFERENCE SIGNS LIST

1, 90 idea generation support system
2 user
3 user idea reception unit
4 idea generation support information presentation unit
5 analogy evoking data selection unit
6 idea candidate database
7, 91 idea candidate classification transfer unit
8 idea classification conversion model database
20 initial idea input screen
25 user idea data
26 idea candidate data
30, 110 analogy evoking screen
50, 120 classification transfer result presentation screen
72, 103, 130 training data
80 examination result screen

1. An idea generation support system that presents information supporting generation of a new idea, the system comprising:
a reception unit that receives a user idea that is a current user's idea;
an idea candidate database in which idea candidates that are existing ideas are accumulated;
a selection unit that selects, from among the idea candidates accumulated in the idea candidate database, the idea candidate associated with the user idea as a first idea candidate;
a classification transfer unit that generates a second idea candidate in which a classification of the first idea candidate selected by the selection unit is converted into a classification of the user idea; and
a presentation unit that presents the user idea, the first idea candidate, and the second idea candidate to a user in association with each other.

2. The idea generation support system according to claim 1, further comprising a conversion model database that stores one or more conversion models,
wherein, in the idea candidate database, data of each of the idea candidates includes classification information indicating a classification of the idea candidate, and
the classification transfer unit estimates the classification of the user idea, and generates the second idea candidate in which the classification of the first idea candidate is converted into the classification of the user idea by using the corresponding conversion model from among the conversion models stored in the conversion model database, based on the estimated classification of the user idea and the classification of the first idea candidate.

3. The idea generation support system according to claim 2, wherein
a content of each of the idea candidates is expressed by a text or a sentence, and
the conversion model converts the classification of the first idea candidate into the classification of the user idea by replacing a word with a word in the classification of the user idea while maintaining syntax of a text or a sentence of the first idea candidate.

4. The idea generation support system according to claim 2, wherein the conversion model is a conversion model trained using training data for converting an idea candidate in the same classification as the first idea candidate into the same classification as the user idea.

5. The idea generation support system according to claim 1, wherein
a content of each of the idea candidates is expressed by a text or a sentence, and
the classification transfer unit generates the second idea candidate in which the classification of the first idea candidate is converted into the classification of the user idea by using a conversion model trained with a sentence, as training data, obtained by combining a first text or sentence expressing a content of the first idea candidate, a second text or sentence in which a word of the first idea candidate is replaced with a word of the user idea, and a different third text or sentence belonging to the same classification as the idea candidate.

6. An idea generation support method executed by an idea generation support system that presents information supporting generation of a new idea, the method comprising:
a first step of receiving a user idea that is a current user's idea;
a second step of selecting, from among idea candidates accumulated in an idea candidate database in which the idea candidates that are existing ideas are accumulated, the idea candidate associated with the user idea as a first idea candidate;
a third step of generating a second idea candidate in which a classification of the selected first idea candidate is converted into a classification of the user idea; and
a fourth step of presenting the user idea, the first idea candidate, and the second idea candidate to a user in association with each other.

7. The idea generation support method according to claim 6, wherein
the idea generation support system has a conversion model database that stores one or more conversion models,
in the idea candidate database, data of each of the idea candidates includes classification information indicating a classification of the idea candidate, and
in the third step, the idea generation support system estimates the classification of the user idea, and generates the second idea candidate in which the classification of the first idea candidate is converted into the classification of the user idea by using the corresponding conversion model from among the conversion models stored in the conversion model database, based on the estimated classification of the user idea and the classification of the first idea candidate.

8. The idea generation support method according to claim 7, wherein
a content of each of the idea candidates is expressed by a text or a sentence, and
the conversion model converts the classification of the first idea candidate into the classification of the user idea by replacing a word with a word in the classification of the user idea while maintaining syntax of a text or a sentence of the first idea candidate.

9. The idea generation support method according to claim 7, wherein the conversion model is a conversion model trained using training data for converting an idea candidate in the same classification as the first idea candidate into the same classification as the user idea.

10. The idea generation support method according to claim 6, wherein
a content of each of the idea candidates is expressed by a text or a sentence, and
in the third step, the idea generation support system generates the second idea candidate in which the classification of the first idea candidate is converted into the classification of the user idea by using a conversion model trained with a sentence, as training data, obtained by combining a first text or sentence expressing a content of the first idea candidate, a second text or sentence in which a word of the first idea candidate is replaced with a word of the user idea, and a different third text or sentence belonging to the same classification as the idea candidate.
